(19) United States
(12) Patent Application Publication
(10) Pub. No.: US 2011/0075526 A1
(43) Pub. Date: Mar. 31, 2011

(54) Optical Element, Arm Mechanism, and Information Recording Device

(76) Inventors: Koujirou Sekine, Osaka (JP); Naoki Nishida, Shiga (JP); Manami Kuiseko, Kyoto (JP); Kou Osawa, Hyogo (JP); Hiroaki Ueda, Osaka (JP); Hiroshi Oshitani, Hyogo (JP); Hiroshi Hatano, Osaka (JP)

(21) Appl. No.: 12/992,496

(22) PCT Filed: Apr. 15, 2009
(86) PCT No.: PCT/JP2009/057576

§ 371 Date: Nov. 12, 2010

(30) Foreign Application Priority Data
May 14, 2008 (JP) 2008-126877

(51) Int. Cl. G11B 11/00; G02B 5/18; G02B 5/04

(52) U.S. Cl. 369/13.24; 359/566; 359/833; G9B/11

(57) ABSTRACT

Proposed is a technique of guiding light to a waveguide, by which the light use efficiency is increased. In order to achieve the above object, adopted is an optical element comprising, at an outer edge portion thereof, an incident surface on which light from a light source is incident, a diffraction grating surface, and an internal reflection surface which guides light incident from the incident surface to the diffraction grating surface.

### TECHNICAL FIELD

The present invention relates to an information recording device and also relates to an arm mechanism and an optical element which are used for the same. More particularly, the present invention relates to, for example, an optical assist type magnetic recording device using a magnetic field and light for information recording and also relates to an arm mechanism and an optical element which are used for the same.

### BACKGROUND ART

In magnetic recording, as the recording density increases, magnetic bits become more remarkably affected by an external temperature or the like. For this reason, a recording medium having high retention is needed, but when such a recording medium is used, the magnetic field required for recording becomes larger. Though the upper limit of the magnetic field generated by a recording head is determined by a saturation flux density, however, the value approximates to a material limit and cannot be expected to dramatically increase. Then, proposed is a method (thermal assist magnetic recording method) in which in a recording process, magnetic softening is caused by local heating, recording is performed while the retention is low, and then heating is stopped for natural cooling so that the stability of recorded magnetic bits may be ensured.

In the thermal assist magnetic recording method, it is desired to momentarily heat the recording medium and it is not permitted for the heating mechanism and the recording medium to come into contact with each other. For this reason, heating is generally performed by using absorption of light and the method in which heating is performed by using light is referred to as an optical assist type. As an optical assist type magnetic recording head, provided is a head which comprises an optical head portion having a planar waveguide with a light condensing function (PSIM) and a magnetic head portion for performing magnetic recording on a portion irradiated with light emitted from the optical head portion (in, for example, Patent Document 1). The PSIM proposed in Patent Document 1 is provided with a diffraction grating, and considering the ratio (light use efficiency) of the amount of light condensed by the PSIM to the amount of light emitted to the diffraction grating, for an incident angle to the diffraction grating, there is an angle range appropriate to the wavelength of incident light.

### PRIOR-ART DOCUMENTS

### Patent Documents

[Patent Document 1] U.S. Pat. No. 6,944,112

### DISCLOSURE OF INVENTION

### Problems to be Solved by the Invention

Though Patent Document 1 shows emission of light from a light source with the light simply inclined with respect to the diffraction grating, however, no specific description is made on a method of guiding light from the light source to the diffraction grating.

The present invention is intended to solve the above problem, and it is an object of the present invention to propose a technique of guiding light to a waveguide, by which light use efficiency increases.

### Means for Solving the Problems

In order to solve the above problem, the present invention is intended for an arm mechanism. According to a first aspect of the present invention, the arm mechanism comprises an arm portion, a head portion which includes a waveguide provided with a grating coupler and is attached to one end side of the arm portion, and an optical element which is provided on an optical path for light incident on the grating coupler, attached to the arm portion, and has a diffraction grating.

According to a second aspect of the present invention, in the arm mechanism of the first aspect, the optical element includes a prism.

According to a third aspect of the present invention, in the arm mechanism of the first or second aspect, the optical element has at least one reflection surface.

According to a fourth aspect of the present invention, in the arm mechanism of the third aspect, the diffraction grating includes a diffraction grating which consists of a plurality of reflection surfaces and causes a diffraction phenomenon of light by reflection of light on the plurality of reflection surfaces.

The present invention is also intended for an information recording device. According to a fifth aspect of the present invention, the information recording device comprises an arm mechanism as defined in any one of the first to fourth aspects, a light source unit for generating light to be emitted to the head portion through the optical element and a recording medium disposed to be opposed to the head portion, and in the information recording device of the fifth aspect, the head portion emits light to the recording medium to record information into the recording medium.

The present invention is further intended for an optical element. According to a sixth aspect of the present invention, the optical element is disposed on an optical path for light incident on a grating coupler provided in a waveguide, and the optical element has a diffraction grating which changes a direction in which light is emitted in correspondence with variation in an appropriate incident angle of the grating coupler in accordance with variation in a wavelength of light.

According to a seventh aspect of the present invention, the optical element of the sixth aspect includes a prism.

According to an eighth aspect of the present invention, the optical element of the sixth or seventh aspect has at least one reflection surface.

### EFFECTS OF THE INVENTION

By the arm mechanism, the information recording device, and the optical element in accordance with any one of the first to eighth aspects, since the incident angle to the grating coupler is adjusted by the optical element provided on the optical path on the basis of the change in the range of an appropriate incident angle of light to the grating coupler in accordance with the variation in a wavelength, the light use efficiency can be increased.

By the arm mechanism in accordance with the third aspect, it becomes possible to adjust the optical path by the diffraction grating of the optical element, following the change in the range of an appropriate incident angle of light to the grating coupler.

By the information recording device in accordance with the fifth aspect, it is possible to ensure reduction in power consumption for recording of information.

### BRIEF DESCRIPTION OF DRAWINGS

FIG. 1 is a view showing an exemplary schematic configuration of an information recording device in accordance with a preferred embodiment of the present invention;

FIG. 2 is a view showing an exemplary structure of a slider portion in accordance with the preferred embodiment of the present invention;

FIG. 3 is a view showing an exemplary structure of an optical assist unit having a waveguide;

FIG. 4 is a schematic diagram showing an exemplary structure of an arm mechanism;

FIG. 5 is a view showing an example of disposition of an optical element;

FIG. 6 is a table exemplarily showing characteristics of first to fifth light source units;

FIG. 7 is a graph exemplarily showing characteristics of the first to fifth light source units;

FIG. 8 is a schematic cross section showing an exemplary structure of a waveguide grating element;

FIG. 9 is a view for explanation of wavelength dispersion characteristics of the waveguide;

FIG. 10 is a schematic diagram showing an exemplary variation in an appropriate incident angle to the waveguide;

FIG. 11 is a graph showing an exemplary relation between efficiency of light incidence on the waveguide and an incident angle to the waveguide;

FIG. 12 is a schematic diagram showing an exemplary structure of a first optical element portion;

FIG. 13 is a view for explanation on adjustment of the incident angle by the first optical element portion; and

FIG. 14 is a schematic diagram showing an exemplary structure of an optical element portion in accordance with a variation.

### BEST MODE FOR CARRYING OUT THE INVENTION

Hereinafter, the preferred embodiment of the present invention will be discussed with reference to figures.

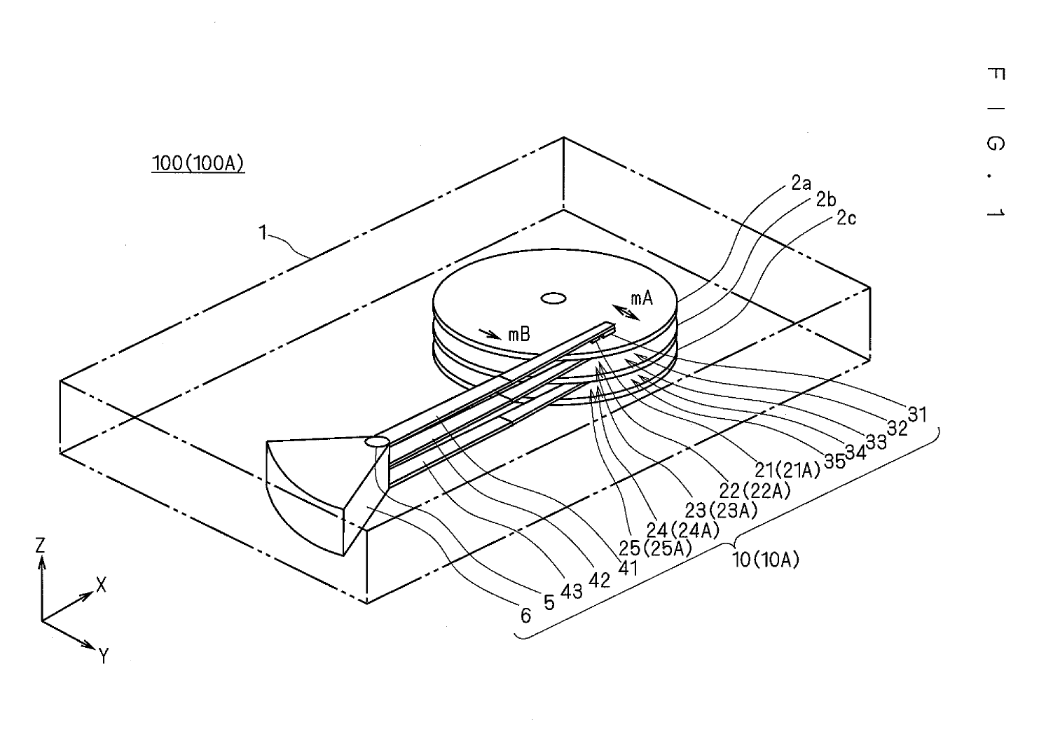

FIG. 1 is a view showing an exemplary schematic configuration of an information recording device 100. In FIG. 1 and the following figures, for clarification of the orientation relation, three axes, i.e., XYZ, which are orthogonal to one another are given as appropriate.

As shown in FIG. 1, the information recording device 100 is configured as a magnetic recording device (optical assist type magnetic recording device) equipped with first to fifth slider portions 31 to 35 which correspond to optical assist type magnetic recording heads, i.e., optical heads, and is applied to, for example, a hard disk device or the like. The information recording device 100 comprises a substantially rectangular parallelepiped case 1, first to third recording disks (magnetic recording media) 2a, 2b, and 2c, and an arm mechanism 10 which are disposed in the case 1.

The first to third recording disks 2a, 2b, and 2c are disk-shaped recording media and arranged away from one another by a predetermined very short distance (e.g., 1 mm or less) so that disk surfaces thereof are substantially in parallel with one another. Specifically, from the upper side (from the +Z side toward the −Z side), the first recording disk 2a, the second recording disk 2b, and the third recording disk 2c are sequentially disposed in space in this order and supported rotatably with respect to the case 1 by a predetermined rotation axis and a motor.

The arm mechanism 10 mainly comprises the first to fifth slider portions 31 to 35, first to fifth optical element portions 21 to 25, first to third arm portions 41 to 43, and a rotation shaft 5.

The first to third arm portions 41 to 43 have the same shape, i.e., elongated thin plate-like shape, and are disposed substantially in parallel with one another. Specifically, from the upper side (from the +Z side toward the −Z side), the first arm portion 41, the second arm portion 42, and the third arm portion 43 are sequentially disposed in space in this order. The first to third arm portions 41 to 43 are connected to one another by the rotation shaft 5 at one end side (herein, the end portion in the −X direction) and supported rotatably with respect to the case 1 in a direction (tracking direction) indicated by the arrow mA with the rotation shaft 5 as a fulcrum. Herein, with rotation of the rotation shaft 5 by an actuator 6, the first to third arm portions 41 to 43 are rotated in the direction indicated by the arrow mA with the rotation shaft 5 as a fulcrum.

The first arm portion 41 to the second arm portion 42 are so arranged as to sandwich the first recording disk 2a and the second arm portion 42 and the third arm portion 43 are so arranged as to sandwich the second recording disk 2b. From another point of view, the second arm portion 42 is so disposed as to be sandwiched between the first recording disk 2a and the second recording disk 2b and the third arm portion 43 is so disposed as to be sandwiched between the second recording disk 2b and the third recording disk 2c.

The first to fifth slider portions 31 to 35 have the same structure and serve as optical heads (which correspond to “head portions” of the present invention) for emitting light to the recording disks 2a, 2b, and 2c.

The first slider portion 31 is so provided at a lower surface of the first arm portion 41 on the other end side which is different from the one end side to which the rotation shaft 5 is connected, as to face one main surface (herein, an upper surface) of the first recording disk 2a, and the second slider portion 32 is so provided at an upper surface of the second arm portion 42 on the other end side which is different from the one end side to which the rotation shaft 5 is connected, as to face the other main surface (herein, a lower surface) of the first recording disk 2a. The third slider portion 33 is so provided at a lower surface of the second arm portion 42 on the other end side which is different from the one end side to which the rotation shaft 5 is connected, as to face one main surface (herein, an upper surface) of the second recording disk 2b, and the fourth slider portion 34 is so provided at an upper surface of the third arm portion 43 on the other end side which is different from the one end side to which the rotation shaft 5 is connected, as to face the other main surface (herein, a lower surface) of the second recording disk 2b. Further, the fifth slider portion 35 is so provided at a lower surface of the third arm portion 43 on the other end side which is different from the one end side to which the rotation shaft 5 is connected, as to face one main surface (herein, an upper surface) of the third recording disk 2c. Thus, the first to fifth slider portions 31 to 35 are held by the first to third arm portions 41 to 43.

Surfaces (slider lower surfaces) of the slider portions 31 to 35, each of which faces any one of the recording disks 2a to 2c, each have a shape of air bearing surface (ABS). Herein, a motor (not shown) for rotating the first to third recording disks 2a to 2c in a direction indicated by the arrow mB is provided in the case 1. When the first to third recording disks 2a to 2c are rotated, the first to fifth slider portions 31 to 35 can be moved relatively, being levitated from the first to third recording disks 2a, 2b, and 2c by a substantially constant distance, above the first to third recording disks 2a, 2b, and 2c.

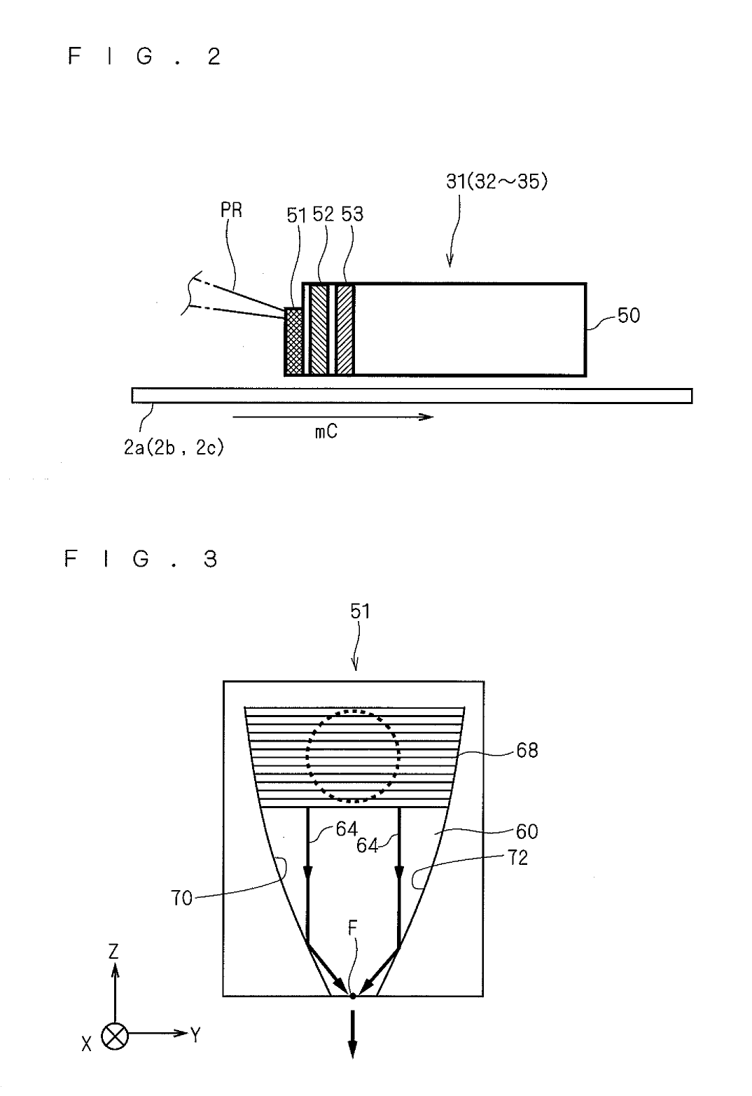

FIG. 2 is a schematic cross section showing an exemplary structure of each of the first to fifth slider portions 31 to 35. As shown in FIG. 2, each of the first to fifth slider portions 31 to 35 has a recording head which uses light for information recording on any one of the first to third recording disks 2a to 2c. Each of the first to fifth slider portions 31 to 35 is formed of, e.g., a substrate 50 made of ceramic or the like, and inside the substrate 50, an optical assist unit 51, a magnetic recording unit 52, and a magnetic reproduction unit 53 are formed in this order from the inflow side toward the outflow side of a recorded portion of the corresponding one of the first to third recording disks 2a to 2c (in a direction indicated by the arrow mC).

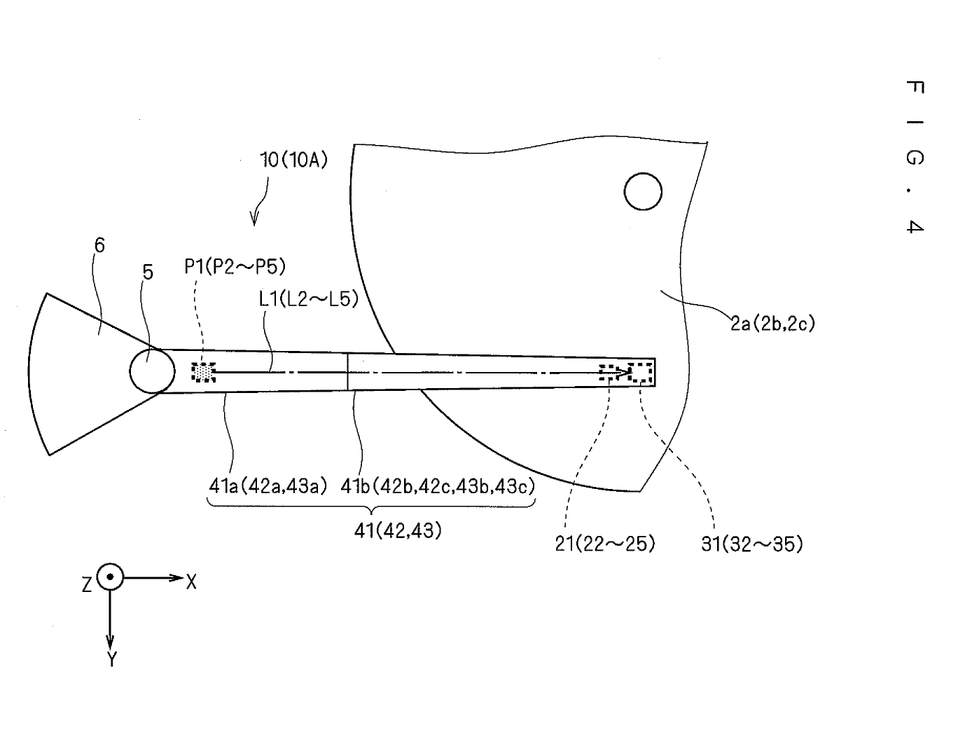

The optical assist unit 51 mainly has an optical waveguide, and the optical waveguide is provided across a side surface and a lower surface of the substrate 50. At an end portion (exit end) of the optical waveguide from which light is emitted, for example, disposed is a metal film provided with a very small rectangular opening. With this, light incident from an end portion (incident end) which is the reverse side of the exit end in the optical waveguide is guided from the side surface side of the substrate 50 up to the lower surface side thereof. It is preferable that the optical waveguide should have a tapered portion for condensing light to the exit end. Then, near-field light is generated at the exit end of the optical waveguide, and a light spot is formed on the corresponding one of the first to third recording disks 2a to 2c and the recorded portion of the corresponding one of the first to third recording disks 2a to 2c is heated by the light spot. The structure of the optical waveguide has a waveguide 60 (see FIG. 3) described later.

FIG. 3 is a view showing an exemplary structure of the optical assist unit 51 having the waveguide 60. As the waveguide 60, a waveguide type solid immersion mirror or a PSIM (planar solid immersion mirror) proposed in, for example, Patent Document 1 can be applied. The waveguide 60 has parabolic inner surfaces 70 and 72 of which the thickness is thin and the width becomes narrower from the upper side toward the lower side. A side surface of an upper portion of the waveguide 60 is provided with a grating coupler which is an optical coupler having a diffraction grating portion 68. When a laser beam is emitted to the diffraction grating portion 68 (specifically, a laser irradiation area inside a portion indicated by the thick broken line) and the laser beam is introduced in the waveguide 60, the laser beam is reflected on the inner surfaces 70 and 72 as indicated by the thick arrow 64 and the laser beam is condensed on a focus F at the lowermost portion of the waveguide 60. Then, an electromagnetic wave is generated toward the corresponding one of the first to third recording disks 2a to 2c and a very small region of the corresponding one of the first to third recording disks 2a to 2c is heated. In FIG. 2, the outline of an optical path PR of the laser beam emitted to the optical assist unit 51 is represented by a one-dot chain line. For increasing the efficiency of incidence of the laser beam to the waveguide 60, there is an appropriate angle (appropriate incident angle) for the incident angle of the laser beam to the diffraction grating portion 68. The appropriate incident angle will be discussed later.

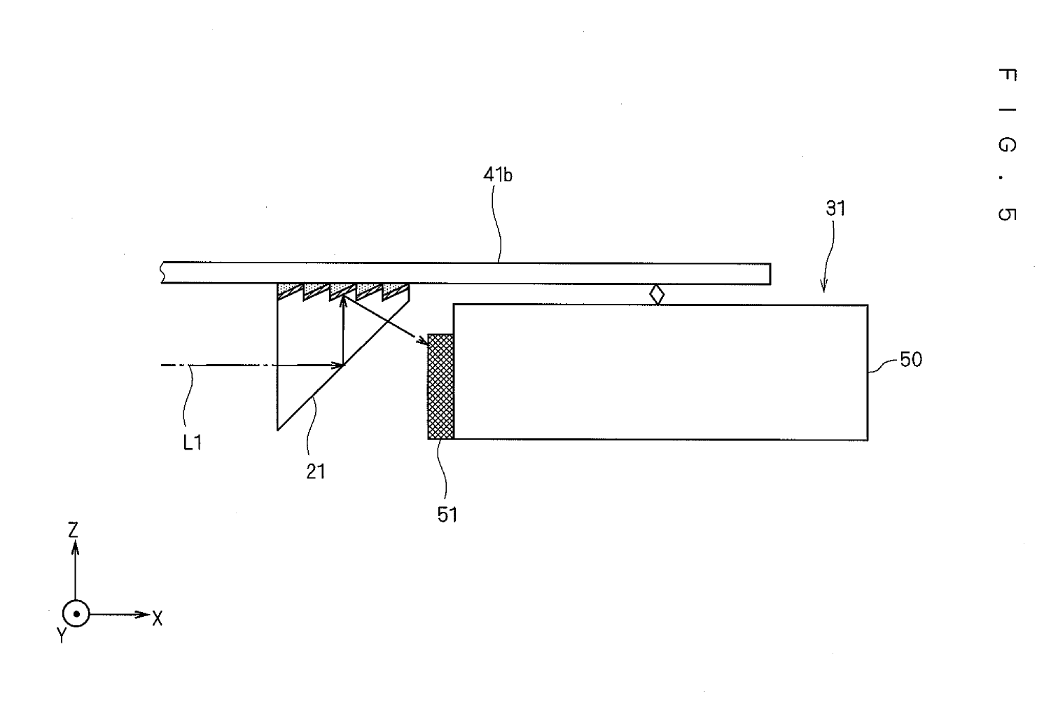

The magnetic recording unit 52 is formed of a magnetic recording element for writing magnetic information on the recorded portion of the corresponding one of the first to third recording disks 2a to 2c. In each of the slider portions 31 to 35, the optical assist unit 51 emits light and the magnetic recording unit 52 records information on the corresponding one of the first to third recording disks 2a to 2c. Though not shown in FIGS. 1 to 3, disposed are first to fifth light source units P1 to P5 (see FIG. 4) for supplying light rays to the first to fifth slider portions 31 to 35, respectively. Each of the first to fifth light source units P1 to P5 is formed of, e.g., a semiconductor laser chip or the like and attached to any one of the arm portions 41 to 43 as appropriate.

The magnetic reproduction unit 53 is formed of a magnetic reproduction element for reading magnetic information recorded in the corresponding one of the first to third recording disks 2a to 2c.

Referring to FIG. 1 again, discussion will continue.

The first to fifth optical element portions 21 to 25 have the same structure, and each of the optical element portions 21 to 25 has a diffraction grating and is attached to any one of the first to third arm portions 41 to 43. The optical element portions 21 to 25 are disposed near the slider portions 31 to 35, respectively, and on the optical paths for light emitted from the light source units P1 to P5 (FIG. 4), respectively, to be incident on the respective diffraction grating portions 68.

Specifically, the first optical element portion 21 is provided on a side of the first slider portion 31 which is closer to the rotation shaft 5, at the lower surface of the first arm portion 41 on the other end side which is different from the one end side to which the rotation shaft 5 is connected, and the second optical element portion 22 is provided on a side of the second slider portion 32 which is closer to the rotation shaft 5, at the upper surface of the second arm portion 42 on the other end side which is different from the one end side to which the rotation shaft 5 is connected. The third optical element portion 23 is provided on a side of the third slider portion 33 which is closer to the rotation shaft 5, at the lower surface of the second arm portion 42 on the other end side which is different from the one end side to which the rotation shaft 5 is connected, and the fourth optical element portion 24 is provided on a side of the fourth slider portion 34 which is closer to the rotation shaft 5, at the upper surface of the third arm portion 43 on the other end side which is different from the one end side to which the rotation shaft 5 is connected. Further, the fifth optical element portion 25 is provided on a side of the fifth slider portion 35 which is closer to the rotation shaft 5, at the lower surface of the third arm portion 43 on the other end side which is different from the one end side to which the rotation shaft 5 is connected. Thus, the first to fifth optical element portions 21 to 25 are held by the first to third arm portions 41 to 43.

<Structure of Arm Mechanism>

FIG. 4 is a schematic diagram showing an exemplary structure of the arm mechanism 10. FIG. 4 is a schematic diagram as the structure of the arm mechanism 10 and in the vicinity thereof is viewed from the upper side (the +Z direction), and in FIG. 4, an arrangement relation of the first to fifth light source units P1 to P5, the first to fifth optical element portions 21 to 25, and the first to fifth slider portions 31 to 35 with respect to the first arm portion 41 is schematically represented by broken lines. In FIG. 4, the optical paths L1 to L5 for light emitted from the light source units P1 to P5 and introduced to the slider portions 31 to 35 through the optical element portions 21 to 25, respectively, are represented by a one-dot chain line. FIG. 5 is a schematic diagram showing an example of disposition of the optical element portion 21. In FIG. 5, the optical path L1 for a laser beam from the first light source unit P1 to the first slider portion 31 is represented by a one-dot chain line.

The first arm portion 41 is constituted of an arm body 41a and a suspension portion 41b. The arm body 41a is formed of a material which is thicker and more rigid than that of the suspension portion 41b and the suspension portion 41b is formed of a material having flexibility. The arm body 41a and the suspension portion 41b extend substantially in the same direction. One end (end portion on the −X side) of the arm body 41a is fixed to the rotation shaft 5 and an upper surface (surface on the +Z side) of one end of the suspension portion 41b is connected to a lower surface (surface on the −Z side) of the other end (end portion on the +X side) of the arm body 41a.

The first slider portion 31 and the first optical element portion 21 are attached to a lower surface of the suspension portion 41b, which is near the other end reverse to the one end connected to the arm body 41a. In more detail, the first slider portion 31 is attached to the suspension portion 41b by using a predetermined spring member and the first optical element portion 21 is attached to the suspension portion 41b with a resin adhesive or the like. Further, the first light source unit P1 is disposed on a lower surface (surface on the −Z side) of the arm body 41a near one end (end portion on the −X side) thereof which is fixed to the rotation shaft 5, and the light emitted from the first light source unit P1 is supplied to the first slider portion 31 through the first optical element portion 21. In other words, the first optical element portion 21 is disposed between the first light source unit P1 and the first slider portion 31, on the optical path of the laser beam which is emitted from the first light source unit P1 and led to the first slider portion 31.

The same configuration consisting of the first light source unit P1, the first optical element portion 21, and the slider portion 31 which are disposed as above is also disposed on the second arm portion 42 and the third arm portion 43.

Specifically, the second arm portion 42 comprises an arm body 42a, an upper suspension portion 42b, and a lower suspension portion 42c all of which extend substantially in the same direction. One end (end portion on the −X side) of the arm body 42a is fixed to the rotation shaft 5, and a lower surface (surface on the −Z side) of one end of the upper suspension portion 42b is connected to an upper surface (surface on the +Z side) of the other end (end portion on the +X side) of the arm body 42a and an upper surface (surface on the +Z side) of one end of the lower suspension portion 42c is connected to a lower surface (surface on the −Z side) of the other end (end portion on the +X side) of the arm body 42a.

The second slider portion 32 and the second optical element portion 22 are attached to an upper surface near the other end reverse to one end of the upper suspension portion 42b which is connected to the arm body 42a. In more detail, the second slider portion 32 is attached to the upper suspension portion 42b by using a predetermined spring member and the second optical element portion 22 is attached to the upper suspension portion 42b with a resin adhesive or the like. The second light source unit P2 is disposed on an upper surface (surface on the +Z side) of the arm body 42a near one end (end portion on the −X side) thereof which is fixed to the rotation shaft 5, and the light emitted from the second light source unit P2 is supplied to the second slider portion 32 through the second optical element portion 22. In other words, the second optical element portion 22 is disposed between the second light source unit P2 and the second slider portion 32, on the optical path of the laser beam which is emitted from the second light source unit P2 and led to the second slider portion 32.

Further, the third slider portion 33 and the third optical element portion 23 are attached to a lower surface near the other end reverse to one end of the lower suspension portion 42c which is connected to the arm body 42a. In more detail, the third slider portion 33 is attached to the lower suspension portion 42c by using a predetermined spring member and the third optical element portion 23 is attached to the lower suspension portion 42c with a resin adhesive or the like. The third light source unit P3 is disposed on a lower surface (surface on the −Z side) of the arm body 42a near one end (end portion on the −X side) thereof which is fixed to the rotation shaft 5, and the light emitted from the third light source unit P3 is supplied to the third slider portion 33 through the third optical element portion 23. In other words, the third optical element portion 23 is disposed between the third light source unit P3 and the third slider portion 33, on the optical path of the laser beam which is emitted from the third light source unit P3 and led to the third slider portion 33.

The third arm portion 43 comprises an arm body 43a, an upper suspension portion 43b, and a lower suspension portion 43c, and the arm body 43a, the upper suspension portion 43b, and the lower suspension portion 43c extend substantially in the same direction. One end (end portion on the −X side) of the arm body 43a is fixed to the rotation shaft 5, and a lower surface (surface on the −Z side) of one end of the upper suspension portion 43b is connected to an upper surface (surface on the +Z side) of the other end (end portion on the +X side) of the arm body 43a and an upper surface (surface on the +Z side) of one end of the lower suspension portion 43c is connected to a lower surface (surface on the −Z side) of the other end (end portion on the +X side) of the arm body 43a.

The fourth slider portion 34 and the fourth optical element portion 24 are attached to an upper surface near the other end reverse to one end of the upper suspension portion 43b which is connected to the arm body 43a. In more detail, the fourth slider portion 34 is attached to the upper suspension portion 43b by using a predetermined spring member and the fourth optical element portion 24 is attached to the upper suspension portion 43b with a resin adhesive or the like. The fourth light source unit P4 is disposed on an upper surface (surface on the +Z side) of the arm body 43a near one end (end portion on the −X side) thereof which is fixed to the rotation shaft 5, and the light emitted from the fourth light source unit P4 is supplied to the fourth slider portion 34 through the fourth optical element portion 24. In other words, the fourth optical element portion 24 is disposed between the fourth light source unit P4 and the fourth slider portion 34, on the optical path of the laser beam which is emitted from the fourth light source unit P4 and led to the fourth slider portion 34.

Further, the fifth slider portion 35 and the fifth optical element portion 25 are attached to a lower surface near the other end reverse to one end of the lower suspension portion 43c which is connected to the arm body 43a. In more detail, the fifth slider portion 35 is attached to the lower suspension portion 43c by using a predetermined spring member and the fifth optical element portion 25 is attached to the lower suspension portion 43c with a resin adhesive or the like. The fifth light source unit P5 is disposed on a lower surface (surface on the −Z side) of the arm body 43a near one end (end portion on the −X side) thereof which is fixed to the rotation shaft 5, and the light emitted from the fifth light source unit P5 is supplied to the fifth slider portion 35 through the fifth optical element portion 25. In other words, the fifth optical element portion 25 is disposed between the fifth light source unit P5 and the fifth slider portion 35, on the optical path of the laser beam which is emitted from the fifth light source unit P5 and led to the fifth slider portion 35.

<Characteristics of Light Source Unit>

The first to fifth light source units P1 to P5 emit light to the first to fifth slider portions 31 to 35 through the first to fifth optical element portions 21 to 25, and are each formed of a cheap Fabry-Perot laser diode which is used for, for example, general-type CD players and DVD recorders.

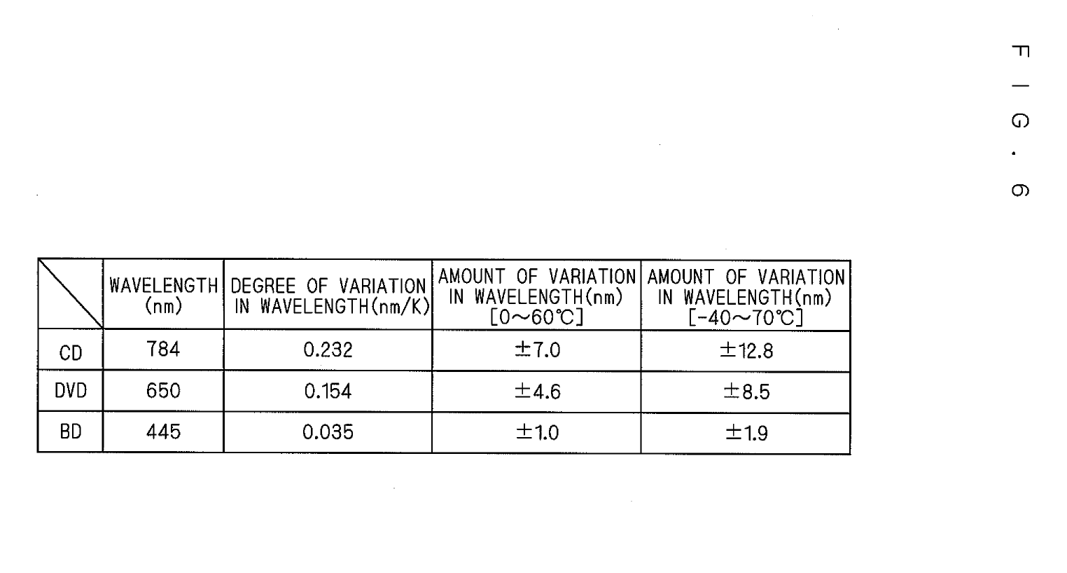

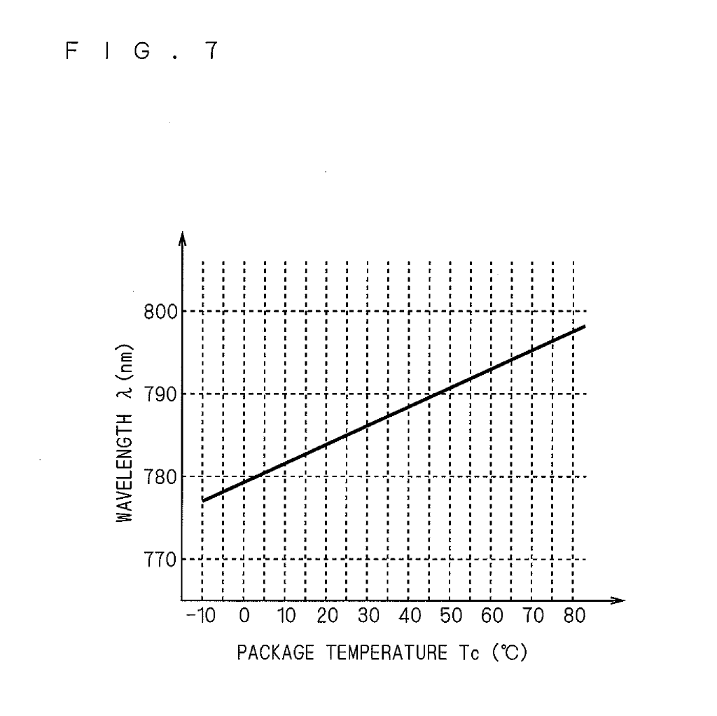

FIGS. 6 and 7 are views each exemplarily showing characteristics of the first to fifth light source units P1 to P5. In FIG. 6, shown are respective characteristics of laser light sources used for general-type CD players, DVD recorders, and Blu-ray Disc (BD) recorders. Specifically, FIG. 6 shows, with respect to each laser light source, the wavelength of a laser beam at a room temperature (25° C.), the degree of variation in the wavelength (the degree of variation in the wavelength) in response to the change in the temperature of the laser light source, the amount of variation in the wavelength (the amount of variation in the wavelength) in a predetermined range of temperature (0 to 60° C.), and the amount of variation in the wavelength (the amount of variation in the wavelength) in a predetermined range of temperature (−40 to 70° C.). FIG. 7 exemplarily shows a temperature dependency of the wavelength of a laser beam emitted from a laser light source used for general-type CD players.

Since each laser light source generates heat to raise the temperature thereof when the laser light source continuously or intermittently emits a laser beam, the wavelength of the laser beam emitted from the laser light source varies. As shown in FIGS. 6 and 7, the amount of variation in the wavelength is somewhat large, i.e., about ±7 mm, for example, even in a normal use environment (in a range of temperature from 0 to 60° C.). The variation in the wavelength causes variation in the appropriate incident angle of the laser beam to the diffraction grating portion 68. Then, in the information recording device 100 of the present preferred embodiment, in order to compensate the variation in the appropriate incident angle, the first to fifth optical element portions 21 to 25 are provided.

Hereinafter, discussion will be sequentially made on characteristics of the diffraction grating portion 68, structure of the first to fifth optical element portions 21 to 25, and compensation of the variation in the appropriate incident angle by using the first to fifth optical element portions 21 to 25.

<Characteristics of Diffraction Grating Portion>

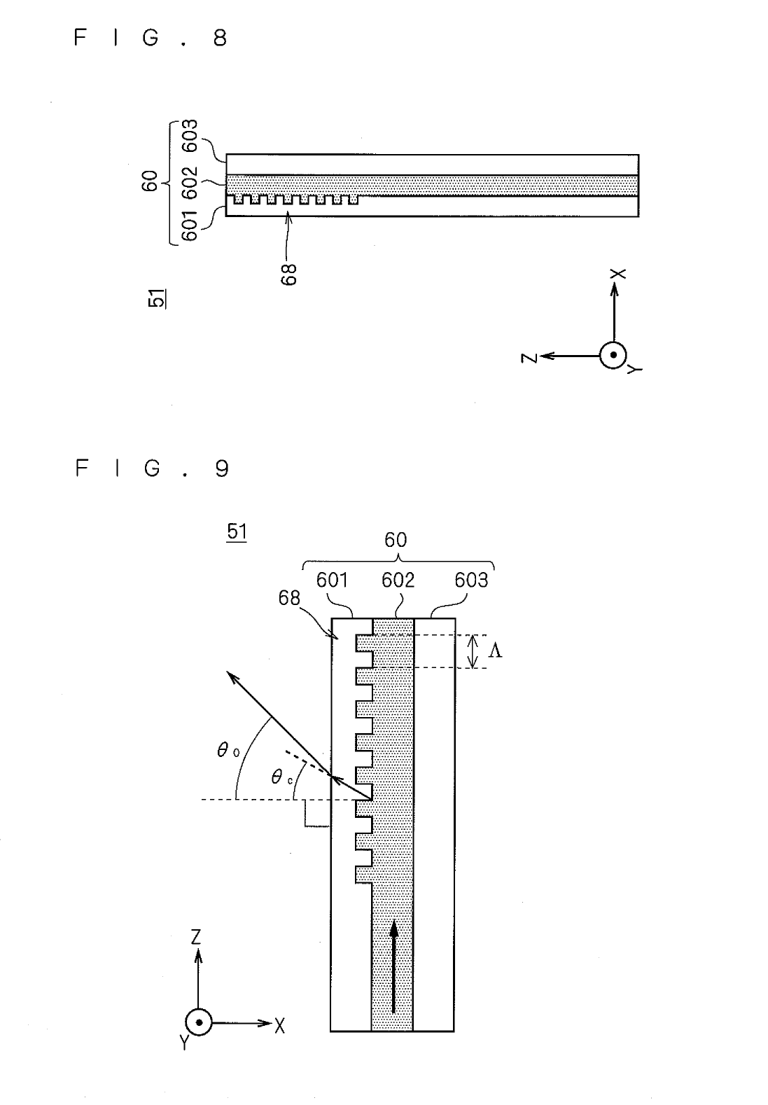

FIG. 8 is a schematic cross section showing an exemplary structure of an element (waveguide grating element) of the waveguide 60 provided with the diffraction grating portion 68.

The waveguide 60 is constituted of a lower clad layer 603, a core layer 602, and an upper clad layer 601 which are layered in this order. The diffraction grating portion 68 for coupling light is provided in the core layer 602 which is sandwiched between the upper clad layer 601 and the lower clad layer 603. The core layer 602 is formed of a material having a refractive index higher than that of each of the clad layers 601 and 603, and the light emitted to the diffraction grating portion 68 is coupled by the diffraction grating portion 68 and propagated in the core layer 602, travelling toward the lower side (in the −Z direction in FIG. 8).

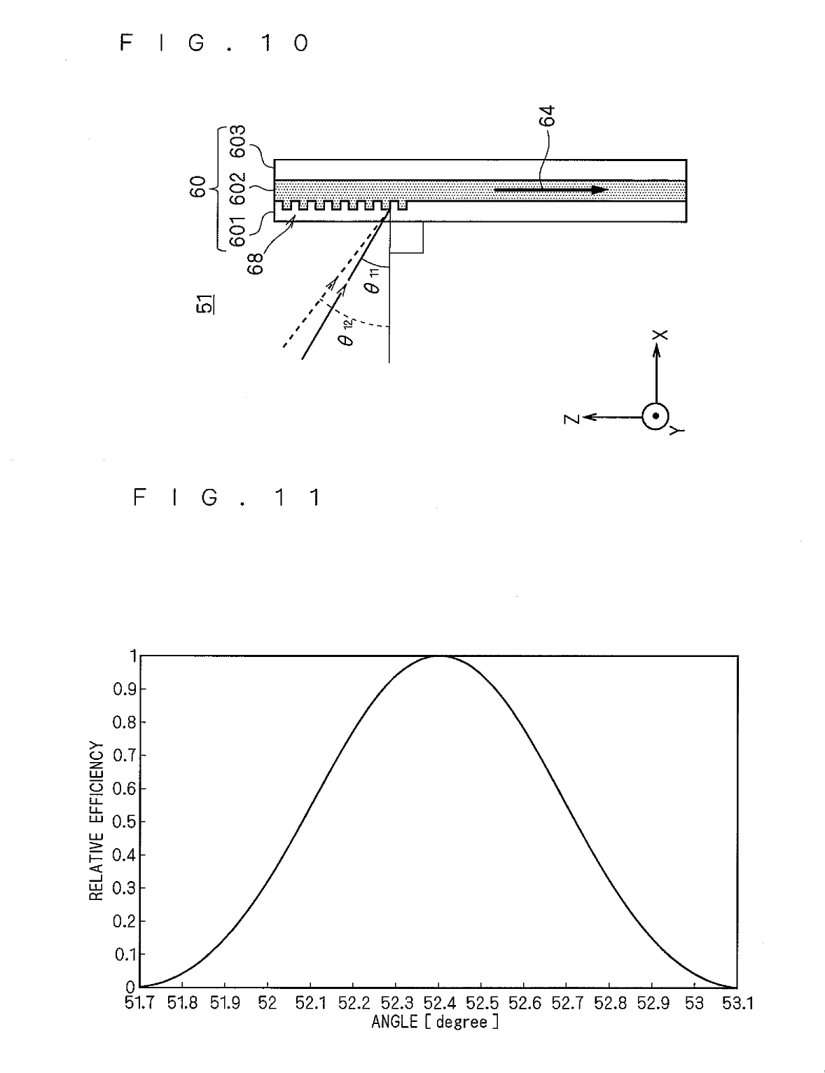

FIG. 9 is a view for explanation of characteristics of wavelength dispersion (wavelength dispersion characteristics) of the waveguide 60. Herein, discussion will be made on characteristics of light emitted from the diffraction grating portion 68 when the light is propagated from the lower side (the −Z direction) toward the upper side (the +Z direction) of the core layer 602. In this discussion, for easy understanding, light is propagated in a direction reverse to that in an actual case where the optical assist unit 51 is used.

Herein, assuming that a propagation constant of a waveguide mode in the core layer 602 is β₀, an angle of a luminous flux emitted to the outside of the waveguide 60 with respect to an XY plane (emission angle to the outside of the substrate) is θ₀, an angle of a luminous flux emitted from the core layer 602 to the upper clad layer 601 with respect to the XY plane (emission angle in the clad layer) is θc, a refractive index in the outside of the waveguide 60 is n₀ (n₀=1 in the air), a refractive index in the upper clad layer 601 is n_{c}, a refractive index in the core layer 602 is n_{f}, an effective refractive index (also referred to as an equivalent refractive index) is N, a cycle of projections and depressions of the diffraction grating portion 68 is Λ, a wavelength of light emitted to the outside of the waveguide 60 is λ, and an order of diffraction is q (herein, only −1), the following equation (1) is true:

β_{q}=n₀×sin θ₀=n_{c}×sin θ_{c}=N+qλ/Λ (1)

Herein, assuming that the refractive index n₀ of the air in the outside of the waveguide 60 is 1.0, the refractive index n_{c} of SiO₂ which is a material of the upper clad layer 601 is 1.47, the refractive index n_{f} of Ta₂O₅ which is a material of the core layer 602 is 2.1, the effective refractive index N is 1.72, the cycle Λ is 0.8462 μm, and the wavelength λ is 785 nm, the emission angle θ₀ to the outside of the substrate is 52.4° from the above equation (1). Therefore, when a light ray having the wavelength λ enters the diffraction grating portion 68 at the emission angle θ₀, the light use efficiency becomes highest and the appropriate incident angle of the light ray having the wavelength λ with respect to the diffraction grating portion 68 is 52.4°. The appropriate incident angle refers to an appropriate value of the angle (the incident angle achieving the highest efficiency of light incidence) of the incident light with respect to the XY plane. As shown in FIGS. 6 and 7, in a case where the wavelength varies by about ±7 nm, the appropriate incident angle also varies by about ±0.78°.

As discussed above, from the effective refractive index N of the waveguide mode in the core layer 602, the cycle Λ of the diffraction grating portion 68, and the like, the appropriate incident angle from the outside of the waveguide 60 to the waveguide 60 can be determined. The appropriate incident angle also depends on the wavelength λ of the light (incident light) incident on the waveguide 60, the appropriate incident angle becomes θ₁₁ when the wavelength is λᵢ and the appropriate incident angle becomes θ₁₂ when the wavelength is λ₂.

When the wavelength λ₁ and the wavelength λ₂ have a relation represented by the following expression (2), as shown in FIG. 10, the appropriate incident angle θ₁₁ and the appropriate incident angle θ₁₂ have a relation represented by the following expression (3).

λ₁>λ₂ (2)

θ₁₁<θ₁₂ (3)

As to the cycle Λ of the diffraction grating portion 68, considering light coupling efficiency, it is preferable to adopt such a cycle as to generate secondary light and tertiary light, and it is preferable to set the cycle to, for example, about half to five times of the wavelength λ. Under such a condition, however, it is preferable that the incident angle of the light incident on the waveguide 60 falls within ±0.1° of the appropriate incident angle.

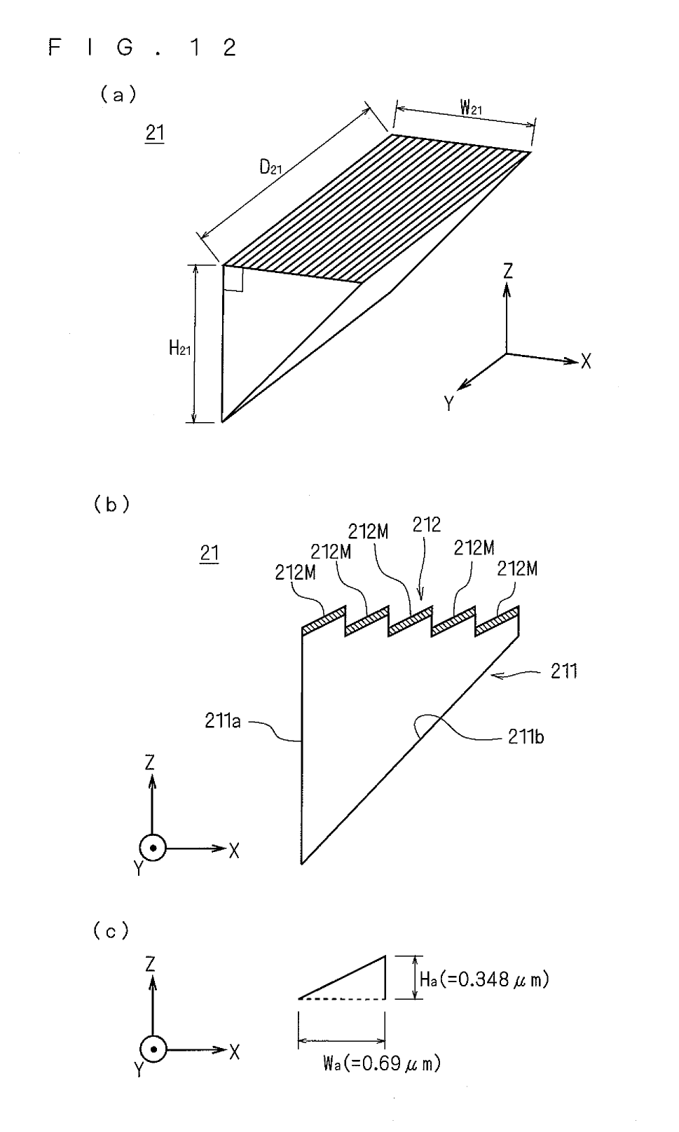

FIG. 11 is a graph showing an exemplary relation between efficiency of light incidence which corresponds to the ratio of the amount of light incident on the waveguide 60 (the amount of incident light) to the amount of light emitted to the waveguide 60 (the amount of emitted light) and an incident angle of the light incident on the waveguide 60. FIG. 11 shows a case where the appropriate incident angle is 52.4° as discussed above, wherein the horizontal axis indicates the incident angle and the vertical axis indicates the efficiency of light incidence (relative efficiency) in a case where the maximum value of the efficiency of light incidence is 1.

As shown in FIG. 11, when it is intended to maintain the relative efficiency, e.g., not lower than 0.9, it is necessary to set the incident angle of the light incident on the waveguide 60 within ±0.1° of the appropriate incident angle of 52.4°.

In contrast to this, in a case where each of the first to fifth light source units P1 to P5 for emitting the light to be incident is formed of a Fabry-Perot laser diode, as discussed above, as the temperatures of the first to fifth light source units P1 to P5 rise, the wavelength λ of the laser beam emitted from each of the first to fifth light source units P1 to P5 becomes larger. Since an angle of diffraction of light in the diffraction grating portion 68 becomes larger, for example, when the wavelength λ of the laser beam becomes larger, the appropriate incident angle of the laser beam becomes smaller, as represented by the above expressions (2) and (3). When a range of operating temperature of the first to fifth light source units P1 to P5 is from 0 to 60° C., for example, the amount of variation in the wavelength λ is about ±7 nm and the appropriate incident angle of the laser beam varies by about ±0.78°. The amount of variation in the appropriate incident angle is much higher than an allowable error of the incident angle (hereinafter, referred to as “allowable error” and in this case, the allowable error is within ±0.1°) in the case where the relative efficiency shown in FIG. 11 is considered. When the incident angle of the laser beam simply becomes higher than the allowable error, this causes a decrease in the efficiency of light incidence even if there is no variation in the positional relation or the angle relation between the luminous flux of the laser beam and the diffraction grating portion 68.

In the information recording device 100 of the present preferred embodiment, however, adjustment is made by the first to fifth optical element portions 21 to 25 so that the incident angle of the laser beam to the diffraction grating portion 68 becomes the appropriate incident angle in accordance with the variation in the wavelength λ of the laser beam while the positional relation between the first to fifth light source units P1 to P5 and the waveguide 60 is maintained.

<Structure of Optical Element Portion and Adjustment of Incident Angle>

The first to fifth optical element portions 21 to 25 have the same structure, and so hereinafter discussion will be made taking the first optical element portion 21 as an example,

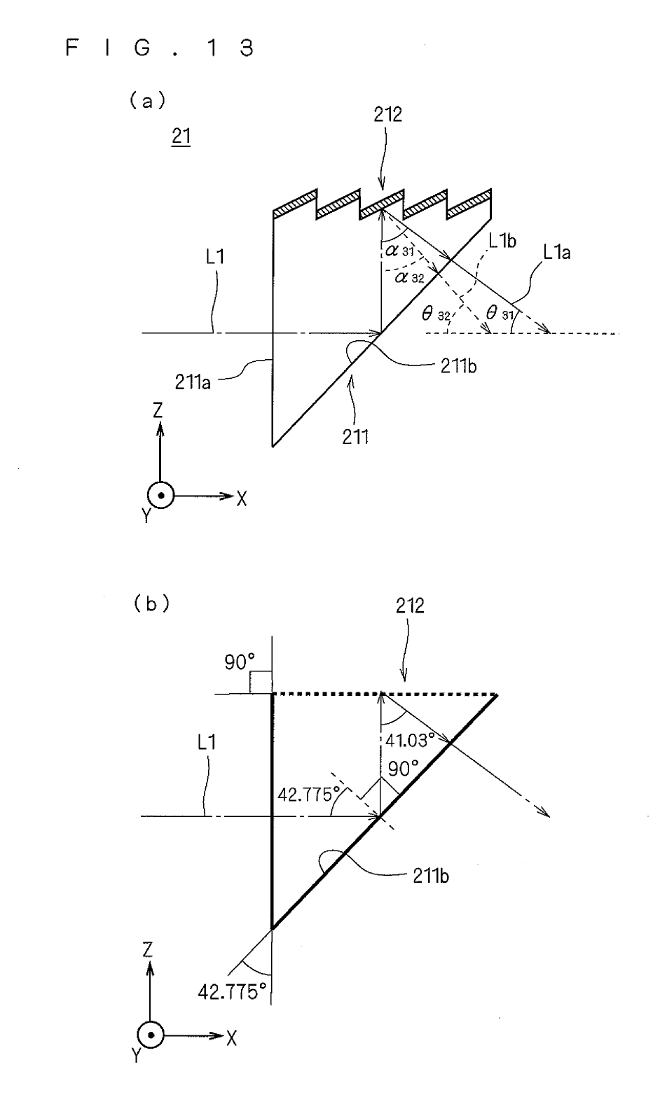

FIG. 12 is a schematic diagram showing an exemplary structure of the first optical element portion 21. FIG. 12(a) is a perspective view schematically showing an exemplary structure of the first optical element portion 21, FIG. 12(b) is a schematic cross section with the first optical element portion 21 cut by the XZ plane, and FIG. 12(c) is a view for explanation of a shape of a reflective diffraction grating portion 212 of the first optical element portion 21. Since an actual shape of the reflective diffraction grating portion 212 is very fine, for clarification of the shape of the reflective diffraction grating portion 212, the projections and depressions of the reflective diffraction grating portion 212 are emphasized as a matter of convenience in FIG. 12.

As shown in FIG. 12(a), the first optical element portion 21 is an optical element (reflective diffraction grating prism) in which a prism portion 211 having a shape of substantially triangular prism, extending along the Y axis, of which the XZ plane has a shape of substantially right triangle which is substantially constant and the reflective diffraction grating portion 212 of which the surface on the +Z side has sawtooth-like projections and depressions along the +X direction are formed integrally. The first optical element portion 21 is entirely formed of a resin, except a reflection film 212M described below. Herein, it is assumed, for example, that the lengths H₂₁ and W₂₁ of two sides sandwiching the right angle of a side surface are set to 240 μm and 222 μm, respectively, and the length D₂₁ extending along the Y axis is set to 1 mm.

As shown in FIG. 12(b), the prism portion 211 has a light incident surface 211a on the −X side on which the laser beam emitted from the first light source unit P1 is incident and an internal reflection surface 211b for reflecting the laser beam travelling in the +X direction to deflect the light by about 90° so that the travelling direction of the laser beam may be changed to the +Z direction. The reflective diffraction grating portion 212 has a so-called blaze shape, of which the XZ section has a sawtooth-like shape in which a plane (inclined plane) ascending linearly in the +Z direction as it travels in the +X direction and a plane (vertical plane) which is substantially in parallel with the YZ plane are repeatedly disposed, and the reflection film 212M is formed on each inclined plane. Therefore, a plurality of inclined planes formed on an upper surface of the reflective diffraction grating portion 212 serve as reflection surfaces, and the laser beam travelling in the +Z direction is reflected on the plurality of inclined planes to cause a light diffraction phenomenon.

The reflection film 212M is formed of, for example, a metal reflection film or a dielectric multilayer film made of aluminum (Al), silver (Ag), or the like. The section of one projection constituted of an inclined plane and a vertical plane in the reflective diffraction grating portion 212 has a shape of substantially right triangle of which the length of the bottom side is Wₐ (herein, 0.69 μm) and the height is Hₐ (herein, 0.348 μm). Hereinafter, a ratio of the length Wₐ of the bottom side and the height Hₐ of one projection in the sawtooth-like shape, specifically a value obtained by dividing the height Hₐ by the length Wₐ of the bottom side, is referred to as an aspect ratio (herein, 0.504).

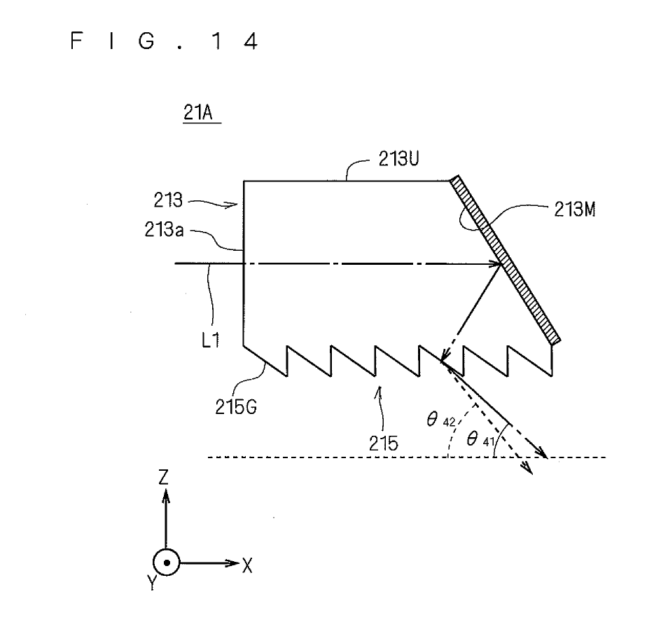

FIG. 13 is a view for explanation on adjustment of the incident angle by the first optical element portion 21. FIG. 13(a) is a schematic diagram exemplarily showing the variation in the incident angle of the laser beam from the first optical element portion 21 in accordance with the variation in the wavelength λ of the laser beam. In FIG. 13(a), a light exit path through which the laser beam emitted from the first light source unit P1 at a predetermined reference temperature (e.g., a room temperature of 25° C.) exits from the reflective diffraction grating portion 212 is represented by a one-dot chain line L1a and a light exit path through which the laser beam emitted from the first light source unit P1 at a low temperature (e.g., 0° C.) exits from the reflective diffraction grating portion 212 is represented by a broken line L1b. FIG. 13(b) is a view showing exemplary set values in a manner of reflection of the laser beam inside the first optical element portion 21.

As shown in FIG. 13(b), for example, an angle made by a luminous flux L1 emitted from the first light source unit P1 at a predetermined reference temperature and the normal of the internal reflection surface 211b is set to 42.775° and an angle (diffraction angle) α₃₁ made by a luminous flux incident on an upper surface of the first optical element portion 21 from the internal reflection surface 211b and a luminous flux exiting from the upper surface of the first optical element portion 21 is set to 41.03°.

Herein, when the wavelength λ₁ and the wavelength λ₂ of the laser beams have such a relation as represented by the above expression (2) with the variation in the temperature of the first light source unit P1, as shown in FIG. 13(a), the diffraction angle α₃₁ in the case of the wavelength λᵢ and a diffraction angle α₃₂ in the case of the wavelength λ₂ have such a relation as represented by the following expression (4).

α₃₁>α₃₂ (4)

As to the incident angle θ of light incident on the diffraction grating portion 68 of the waveguide 60, as shown in FIG. 13(a), an angle (incident angle) θ₃₁ made by a laser beam having the wavelength λ₁ and the XY plane and an angle (incident angle) θ₃₂ made by a laser beam having the wavelength λ₂ and the XY plane have such a relation as represented by the following expression (5).

θ₃₁<θ₃₂ (5)

The variation in the incident angle θ caused by the variation in the temperature of the first light source unit P1 (in other words, the variation in the wavelength λ), which is represented by the expression (5), corresponds to the variation in the appropriate incident angle caused by the variation in the temperature of the first light source unit P1 (in other words, the variation in the wavelength λ), which is represented by the above expression (3). Therefore, by adjusting the shape of the reflective diffraction grating portion 212 (for example, the length Wₐ of the bottom side and the height Hₐ in the section thereof, in other words, the aspect ratio) as appropriate, the variation in the appropriate incident angle in response to the variation in the wavelength λ of the laser beam caused by the variation in the temperature of the first light source unit P1 can be cancelled (i.e., counteracted) by the diffraction phenomenon produced by the first optical element portion 21.

Thus, in the information recording device 100 of the preferred embodiment of the present invention, though the appropriate range of incident angle of the laser beam incident on the diffraction grating portion 68 varies in response to the variation in the wavelength λ of the laser beam emitted from the first to fifth light source units P1 to P5, the incident angle to the diffraction grating portion 68 can be adjusted by the first to fifth optical element portions 21 to 25 each provided on the optical path of the laser beam. This increases the light use efficiency and ensures reduction in power consumption.

Further, in the information recording device 100, generally, the laser beam is emitted from the side to the first to fifth slider portions 31 to 35 and each of gaps between the suspension portions 41b, 42b, 42c, 43b, and 43c and the recording disks 2a, 2b, and 2c is set to 0.5 mm or less, being very narrow, for thinning of the device. In contrast to this, the appropriate incident angle to the diffraction grating portion 68 is generally in a slanting direction. Therefore, it is preferable to adopt a thin optical system which can deflect the light incident on the diffraction grating portion 68 to the slanting direction and compensate the variation in the appropriate incident angle. In order to satisfy this need, the first to fifth optical element portions 21 to 25 of the preferred embodiment are provided as elements which use the reflection therein to compensate the variation in the appropriate incident angle while being thin.

In the first to fifth optical element portions 21 to 25, since the reflective diffraction grating portion 212 is provided on the upper surface of each of the first to fifth optical element portions 21 to 25 and the surface area of the upper surface increases, the adhesive strength increases in bonding the first to fifth optical element portions 21 to 25 onto the suspension portions 41b, 42b, 42c, 43b, and 43c. Therefore, the stability can be increased by fixation of the first to fifth optical element portions 21 to 25.

<Variations>

The present invention is not limited to the above-discussed preferred embodiment but numerous modifications and variations can be devised without departing from the scope of the invention.

For example, though the first to fifth optical element portions 21 to 25 are each formed of a reflective diffraction grating prism having the reflective diffraction grating portion 212 in the above preferred embodiment, this is only one exemplary case. The first to fifth optical element portions 21 to 25 may be each formed of a prism (transmission diffraction grating prism) of which the light exit surface for a laser beam is a transmission diffraction grating. In other words, the first to fifth optical element portions 21 to 25 each have simply to use an optical element having the wavelength dispersion characteristics which cancels the wavelength dispersion characteristics of the diffraction grating portion 68. Hereinafter, a specific example of the first to fifth optical element portions 21A to 25A which are constituent elements of an arm mechanism 10A in an information recording device 100A and each use a transmission diffraction grating prism.

FIG. 14 is a schematic diagram showing an exemplary structure of the first optical element portion 21A in accordance with this variation. Specifically, FIG. 14 is a schematic cross section with the first optical element portion 21A cut by the XY plane. Since an actual shape of a transmission diffraction grating portion 215 is very fine, for clarification of the shape of the transmission diffraction grating portion 215, the projections and depressions of the transmission diffraction grating portion 215 are emphasized as a matter of convenience in FIG. 14.

The first optical element portion 21A is an optical element in which a prism portion 213 having a shape of substantially square pole, extending along the Y axis, of which the XY plane has a shape of substantially trapezoid which is substantially constant and the transmission diffraction grating portion 215 of which the bottom surface (surface on the −Z side) has sawtooth-like projections and depressions along the +X direction are formed integrally.

As shown in FIG. 14, the prism portion 213 has a light incident surface 213a on the −X side on which the laser beam emitted from the first light source unit P1 is incident, an upper surface 213U which is substantially in parallel with the XY plane, and a tilted reflection surface 213M for reflecting the laser beam travelling in the +X direction on a covered reflection film (fowled of, for example, Al, Ag, or the like) to deflect the light by about 60° so that the travelling direction of the laser beam may be changed to diagonally downward (diagonally downward toward left in FIG. 14). The transmission diffraction grating portion 215 has a so-called blaze shape, of which the XZ section has a sawtooth-like shape in which a plane (inclined plane) descending linearly in the −Z direction as it travels in the +X direction and a plane (vertical plane) which is substantially in parallel with the YZ plane are repeatedly disposed, and has a lower surface (light exit surface) 215G through which the laser beam is transmitted to exit. The light exit surface 215G produces a diffraction phenomenon of the laser beam.

As to the incident angle θ of light incident on the diffraction grating portion 68 of the waveguide 60, when the wavelength λ₁ and the wavelength λ₂ of the laser beams have such a relation as represented by the above expression (2) with the variation in the temperature of the first light source unit P1, as shown in FIG. 14, an angle (incident angle) θ₄₁ made by a laser beam having the wavelength λᵢ and the XY plane and an angle (incident angle) θ₄₂ made by a laser beam having the wavelength λ₂ and the XY plane have such a relation as represented by the following expression (6).

θ₄₁<θ₄₂ (6)

The variation in the incident angle θ caused by the variation in the temperature of the first light source unit P1 (in other words, the variation in the wavelength λ), which is represented by the expression (6), corresponds to the variation in the appropriate incident angle caused by the variation in the temperature of the first light source unit P1 (in other words, the variation in the wavelength λ), which is represented by the above expression (3). Therefore, by adjusting the blaze shape of the transmission diffraction grating portion 215 as appropriate, the variation in the appropriate incident angle in response to the variation in the wavelength λ of the laser beam caused by the variation in the temperature of the first light source unit P1 can be cancelled (i.e., counteracted) by the diffraction phenomenon produced by the first optical element portion 21A.

Thus, though adopting the first optical element portion 21A produces the same effect as that in the above preferred embodiment, from the viewpoint that it is intended to facilitate the manufacturing operation by reducing the ratio (aspect ratio) between the length of the bottom surface and the height of one projection in the sawtooth-like shape, the reflective diffraction grating prism is preferable to the transmission diffraction grating prism. On the other hand, as the distance between the diffraction grating portion of the optical element portion and the diffraction grating portion 68 of the waveguide 60 becomes shorter, the position at which the laser beam is emitted to the diffraction grating portion 68 becomes less deviated by the variation in the wavelength λ of the laser beam. Therefore, from this point of view, in the first optical element portion 21A using the transmission diffraction grating portion 215, it is easier to make preferable position setting. Further, as to covering of a material (reflection material) for the reflection film, the first optical element portion 21A formed by covering a flat surface with the reflection material is preferable because of easier manufacturing operation.

Further, though the laser beam is reflected on the reflection film in the above preferred embodiment and the above specific example, there may be a case where no reflection film is used and reflection of the laser beam is made by adjusting the refractive index of a material for the prism and using total reflection.

Though the first to fifth optical element portions 21 to 25 each including the reflective diffraction grating portion 212 are adopted in the above preferred embodiment and the first to fifth optical element portions each including the transmission diffraction grating portion 215 are adopted in the above specific example, these are only exemplary cases. Without providing the diffraction grating portion, various optical elements each having wavelength dispersion characteristics, such as a prism using a material having a refractive index which is much higher than that in the air, may be adopted.

Though the information recording devices 100 and 100A are each an optical assist type magnetic recording device which gives heat to the recording medium by using light to magnetically record and read information in the above preferred embodiment and the specific example, this is only one exemplary case. The present invention may be applied to, for example, general information recording devices which record and read information by using light irradiation, such as an information recording device which records and reads information by irradiating a recording medium with light, not magnetically. In other words, the present invention may be applied to general information recording devices which record information into a recording medium by using an optical head for irradiating the recording medium with light.

Though a laser beam is reflected twice inside the first to fifth optical element portions 21 to 25 of the above preferred embodiment and a laser beam is reflected once inside the first optical element portions 21A to 25A of the specific example, these are only exemplary cases.

Even if a laser beam is not reflected and the diffraction grating simply deflects the travelling direction of the laser beam by using the diffraction phenomenon in front of the diffraction grating portion 68, however, the travelling direction of the laser beam cannot be deflected to a direction where the variation in the appropriate incident angle in response to the variation in the wavelength λ of the laser beam which is caused by the variation in the temperature of the light source unit can be cancelled (i.e., counteracted) by the diffraction phenomenon produced by the front diffraction grating. Therefore, it is necessary to reflect the laser beam once or more before the laser beam is incident on the diffraction grating portion 68 and provide one or more reflection surfaces in each of the first to fifth optical element portions 21 to 25 or 21A to 25A. Depending on the direction of the inclined plane in the sawtooth-like shape of the diffraction grating portion included in each of the first to fifth optical element portions 21 to 25 or 21A to 25A, the number of reflections of the laser beam (odd number or even number) is determined, and following the change of the range of the appropriate incident angle to the diffraction grating portion 68, the optical path can be adjusted by the first to fifth optical element portions 21 to 25 or 21A to 25A.

Though the first to fifth light source units P1 to P5 are each formed of a semiconductor laser chip in the above preferred embodiment, this is only one exemplary case. The first to fifth light source units P1 to P5 may be each formed of any one of various optical elements, such as a light emitting diode (LED) or the like.

Though the incident angle to the diffraction grating portion 68 may be adjusted by adjusting the position and angle of each of the first to fifth light source units P1 to P5 as appropriate, since changing the position and angle of each of the first to fifth light source units P1 to P5 disadvantageously causes an unstable operation of the information recording device 100 and an increase in the power consumption in moving units, it is preferable to adjust the incident angle by the first to fifth optical element portions 21 to 25 or 21A to 25A.

Though the first optical element portion 21 is entirely formed of a resin, except the reflection film 212M in the above preferred embodiment, the material is not limited to the resin. The first optical element portion 21 except the reflection film 212M may be formed of, for example, glass or the like.

Further, though the prism portion 211 and the reflective diffraction grating portion 212 which constitute the first optical element portion 21 are formed of a resin in the above preferred embodiment, this is only one exemplary case. There may be a case, for example, where the prism portion 211 is formed of glass while the reflective diffraction grating portion 212 is formed of a resin.

### DESCRIPTION OF REFERENCE NUMERALS

2a to 2c first to third recording disks
10, 10A arm mechanism
21 to 25, 21A to 25A first to fifth optical element portions
31 to 35, 31A to 35A first to fifth slider portions
41 to 43 first to third arm portions
51 optical assist unit
60 waveguide
68 diffraction grating portion
100, 100A information recording device
211, 213 prism portion
211a, 213a light incident surface
212 reflective diffraction grating portion
212M reflection film
213M tilted reflection surface
215 transmission diffraction grating portion
211b, 215G light exit surface
P1 to P5 first to fifth light source units

1.-8. (canceled)

9. An optical element comprising, at an outer edge portion thereof, an incident surface on which light from a light source is incident, a diffraction grating surface, and an internal reflection surface which guides light incident from said incident surface to said diffraction grating surface.

10. The optical element according to claim 9, further comprising an emitting surface from which light is emitted, wherein
said diffraction grating surface is a reflective diffraction grating surface.

11. The optical element according to claim 10, wherein
said diffraction grating surface has a metal reflection film or a dielectric multilayer film.

12. The optical element according to claim 9, wherein
said diffraction grating surface is a transmission diffraction grating surface.

13. A prismatic optical element comprising, at an outer edge portion thereof, an incident surface on which light from a light source is incident, a diffraction grating surface, and a light-emitting surface which emits light from said diffraction grating surface.

14. The prismatic optical element according to claim 13, wherein
said diffraction grating surface is a reflective diffraction grating surface.

15. The prismatic optical element according to claim 14, wherein
said diffraction grating surface has a metal reflection film or a dielectric multilayer film.

16. An optical assist type magnetic recording head comprising:
a light source;
a slider portion which has a waveguide and a grating coupler for coupling incident light to said waveguide, and which emits light emitted from said waveguide to a recording medium; and
an optical element which guides light from said light source to said grating coupler,
wherein
the incident light incident on said grating coupler from said optical element is diffracted in a diffraction grating portion included in said optical element,
the light incident on said optical element from said light source is reflected by an internal reflection surface included in said optical element, and emitted to said diffraction grating portion.

17. The optical assist type magnetic recording head according to claim 16, wherein
said diffraction grating portion is a reflective diffraction grating portion.

18. The optical assist type magnetic recording head according to claim 17, wherein
said diffraction grating portion has a metal reflection film or a dielectric multilayer film.

19. The optical assist type magnetic recording head according to claim 16, wherein
said diffraction grating portion is a transmission diffraction grating portion.
